(19) United States
(12) Patent Application Publication
(10) Pub. No.: US 2012/0111266 A1
(43) Pub. Date: May 10, 2012

(54) PROCESSING APPARATUS FOR PREPARING LITHOGRAPHIC PRINTING PLATES

(76) Inventors: Seiji Noge, Tokyo (JP); Yukihiro Yamakoshi, Tokyo (JP); Tomohiko Mori, Tokyo (JP)

(21) Appl. No.: 13/267,058

(22) Filed: Oct. 6, 2011

(30) Foreign Application Priority Data
Nov. 5, 2010 (JP) 2010-248912

(51) Int. Cl. B05C 1/08

(52) U.S. Cl. 118/255

(57) ABSTRACT

A protective gum solution coating apparatus for coating a protective gum solution on a lithographic printing plate precursor comprises a pair of upstream side rollers in a gum section, a pair of downstream side rollers in the gum section, and a protective gum solution feeding device, wherein, in a plane orthogonal to the axes of the rollers. An upper roller of the pair of downstream side rollers inclines to a direction opposite to a direction where the lithographic printing plate precursor progresses so that an angle “a” between a line which links the centers of the lower roller and the upper roller of the pair of downstream side rollers and a line which links the center of the lower roller of the pair of downstream side rollers and the contact point CP becomes 0<a≦5 degrees.

### CROSS REFERENCE TO RELATED APPLICATIONS

This application claims priority to Japanese Patent Application No. 2010-248912 filed on Nov. 5, 2010, which is incorporated herein by reference in its entirety.

### FIELD OF THE INVENTION

The present invention relates to an automatic plate processor which includes a protective gum solution coating apparatus which coats a developed lithographic printing plate precursor with a protective gum solution while conveying it by rolls after rinsing.

### BACKGROUND OF THE INVENTION

Among lithographic printing plate precursors which are to be treated using alkali developing solutions, lithographic printing plate precursors which are comprised of hydrophilic supports on which are provided image forming layers which contain compositions which change in solubility with respect to the alkali developing solutions due to chemical rays or heat are known. These are exposed by bringing silver salt mask films on which images have been recorded in advance into close contact with the photosensitive surfaces of the lithographic printing plate precursors.

On the other hand, along with the advances in computer image processing, lithographic printing plate precursors for direct photosensitive or thermosensitive platemaking which are formed with images directly by laser beams or thermal heads etc. from digital image information without output to silver salt mask films have come under the spotlight.

If these lithographic printing plate precursors are image-wise exposed to light or heat, cured area corresponding to the image area in the final printed matter or area dissolvable by the treatment solution corresponding to the non-image area will be formed. The non-image part regions are dissolved away by an alkali treatment solution.

Usually, these lithographic printing plate precursors are developed by automatic plate processors. In the final step of development (or the gum section), a plate surface protective agent (also called a “desensitizing solution” or “protective gum solution”) is coated over the plate surface of the printing plate precursor on which the image is formed. By using the protective gum solution to cover the entire plate surface, the hydrophilicity of the support surface at the non-image regions is maintained. Further, contamination of the plate surface due to fingermarks or deposition of grease, dust, etc. at the time of storage in the period until platemaking and printing and at the time of handling at the time of mounting to a printing press is prevented. Further, the scratch resistant strength is improved.

In general, at the final step of development (or the gum section), the developed lithographic printing plate precursor passes through a pair of upstream side rollers (pair of conveyor rollers), then the protective gum solution is sprayed on an upper roller and/or lower roller of a pair of downstream side rollers of the gum section (hereinafter referred to as the “pair of gum rollers”) using a gum solution sprayer at the lithographic printing plate precursor. When the lithographic printing plate precursor passes through the pair of gum rollers, the lithographic printing plate precursor is uniformly coated by the protective gum solution. After that, the lithographic printing plate precursor on which the protective gum solution is coated is sent to a drying step.

To uniformly coat the protective gum solution on the lithographic printing plate precursor, in the past, various measures have been taken in the protective gum solution coating step at the protective gum solution coating apparatus or plate processor. For example, Japanese Utility Model Publication (A) No. 62-185065 describes to solve the problem of the insufficient coating of the desensitizing agent at the end faces of a printing plate, in particular the front end face when viewed in plate feed direction, by a plate desensitizing apparatus characterized by moving an upper plate feed roller to the plate feed direction with respect to a lower plate feed roller among the pair of plate feed rollers of a desensitizing solution feed apparatus which feeds a desensitizing solution.

Japanese Utility Model Publication (A) No. 2-112430 describes to prevent a gum solution from flowing back to the pair of conveyor rollers by a plate desensitizing apparatus characterized by making a slant angle of the pair of gum solution coating rollers further larger in the plate feed direction than the slant angle of the pair of conveyor rollers set right before them.

Further, in the past, when developing a lithographic printing plate precursor, the problem arose of a considerable amount of the protective gum solution remaining on the plate surface at the rear end part of the coated printing plate precursor after passing through the gum solution coating apparatus. This residual gum solution sometimes was not sufficiently dried at the drying step and caused stacked printing plates to stick together (blocking) when storing printing plate precursors stacked up after the drying step.

Japanese Patent Publication (A) No. 7-244371 describes to eliminate the protective gum solution remaining at the rear end part of a printing plate by a lithographic printing plate platemaking apparatus which uses as the material of the coating surfaces of the protective gum solution coating rolls at the protective gum solution processing part a hydrophilic material with a porosity of 70% or more so as to absorb the excess gum solution. However, with this apparatus, causing the gum solution to be absorbed requires control of the pressure of the coating rolls. Further, it is necessary to squeeze out the protective gum solution which the coating rolls have absorbed after the end of the work so as to restore the gum solution absorption ability.

### SUMMARY OF THE INVENTION

This present invention provides a protective gum solution coating apparatus which coats a developed lithographic printing plate precursor with a protective gum solution while conveying it by rolls and an automatic plate processor including such a coating apparatus wherein, without using special surface-treated protective gum solution coating rolls, no residual gum solution is caused on the plate surface of the rear end part of the printing plate on which the protective gum solution is coated and therefore a simple protective gum solution coating apparatus is provided.

As a result of in-depth studies to solve the above problem, the inventors discovered that by changing the position and diameter of the upper roller in a pair of downstream side rollers (pair of gum rollers) of a gum section of a protective gum solution coating apparatus for coating a protective gum solution, unexpectedly no residual gum solution is formed on the plate surface at the rear end part of the printing plate precursor, and thereby completed the present invention.

That is, the present invention provides a protective gum solution coating apparatus for coating a protective gum solution on a lithographic printing plate precursor comprising a pair of upstream side rollers in a gum section, a pair of downstream side rollers in the gum section, and a protective gum solution feeding device, wherein, in a plane orthogonal to the axes of the rollers,

when a contact point between a common tangent of a lower roller of said pair of upstream side rollers and a lower roller of said pair of downstream side rollers and the lower roller of said pair of downstream side rollers is CP,

an upper roller of said pair of downstream side rollers inclines to a direction opposite to a direction where the lithographic printing plate precursor progresses so that an angle “a” between a line which links the centers of the lower roller and the upper roller of said pair of downstream side rollers and a line which links the center of the lower roller of said pair of downstream side rollers and said contact point CP becomes 0<a≦5 degrees.

As one aspect of the present invention, an automatic plate processor which has such a protective gum solution coating apparatus built into it may be mentioned.

### BRIEF DESCRIPTION OF THE DRAWINGS

FIG. 1 is a view showing a cross-section of an automatic plate processor of a lithographic printing plate precursor.

FIG. 2 is a view showing outlines of a protective gum solution coating section of the automatic plate processor shown in FIG. 1.

FIG. 3(a) is a view showing the state where protective gum solution remains at the rear end part of a lithographic printing plate precursor, while (b) is a view showing the state of the pool of the protective gum solution which causes the protective gum solution to remain.

FIG. 4 is a view showing one aspect of the protective gum solution coating apparatus of the present invention.

FIG. 5 is an enlarged view of the protective gum solution coating apparatus of the present invention shown in FIG. 4.

### DETAILED DESCRIPTION

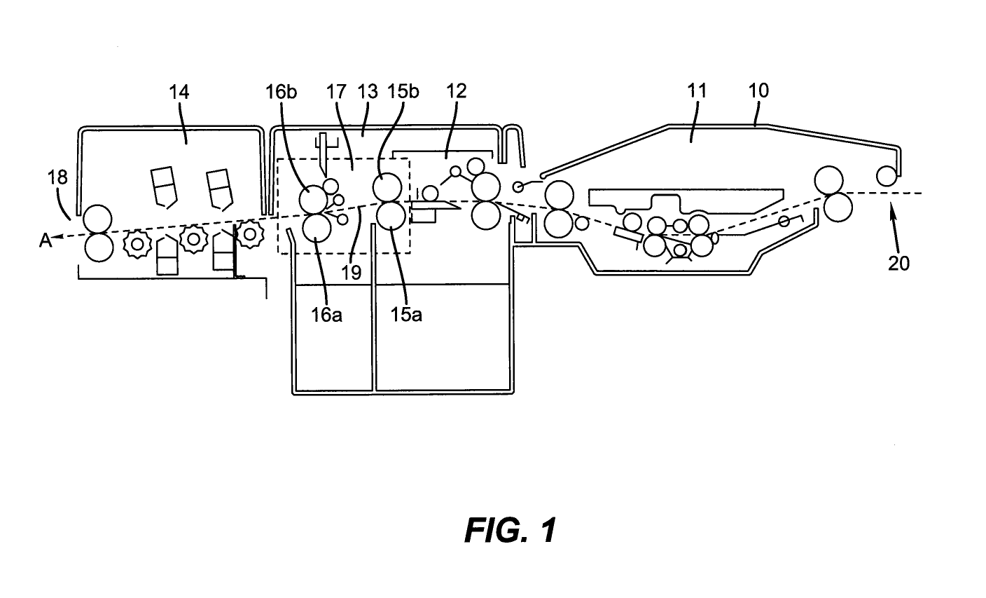

The present invention will be explained below with reference to FIGS. 1 to 5. For convenience in explanation of the present invention, cross-sectional views are used for the explanation, but the following explanation should be understood as an explanation in a plane orthogonal to the axes of the rollers of the protective gum solution coating apparatus.

In the following drawings, the protective gum solution coating apparatus of the present invention will be explained relating to an aspect where it is built into an automatic plate processor for a lithographic printing plate precursor, but this does not limit the protective gum solution coating apparatus of the present invention in any way. An aspect where it is included in a development system as an independent processor is of course also one aspect of the present invention.

FIG. 1 is a view showing a cross-section of an automatic plate processor 10 of a lithographic printing plate precursor. The automatic plate processor 10 is usually comprised of a development section 11, a rinse section 12, a protective gum solution coating section 13, and a drying section 14. Each section has conveyor rollers arranged in it. A lithographic printing plate precursor is image-exposed by an exposure apparatus (not shown) then inserted from an insertion opening 20 of the automatic plate processor, whereupon the conveyor rollers rotate by a predetermined speed to convey the exposed lithographic printing plate through the development section 11, rinse section 12, protective gum solution coating section (also simply called the “gum section”) 13, and the drying section 14 in that order in the direction of the arrow A, then is discharged from a discharge opening 18. The path from the insertion opening 20 to the discharge opening 18 over which the lithographic printing plate precursor passes is called the “path line 19”. The “path line” is the path over which the lithographic printing plate precursor actually passes inside the automatic plate processor, so is not necessarily straight. Usually, the path between the conveyor rollers (including gum rollers) is substantially straight, but after passing conveyor rollers, sometimes the path swings up or down in accordance with the subsequently arranged conveyor rollers.

The protective gum solution coating section 13 (part surrounded by broken line) has a pair of upstream side rollers (hereinafter also referred to as “a pair of conveyor rollers”) 15a and 15b, a pair of downstream side rollers (pair of gum rollers) 16a and 16b, and a pair of protective gum solution feeding devices 17. In FIG. 1, the pair of conveyor rollers 15a and 15b are arranged at the transition part between the rinse section 12 and the protective gum solution coating section 13, but when the protective gum solution coating apparatus is included in a development system as an independent processor, a pair of conveyor rollers may also be arranged inside of the rinse section 12 to convey the rinsed lithographic printing plate precursor to the gum solution coating section 13.

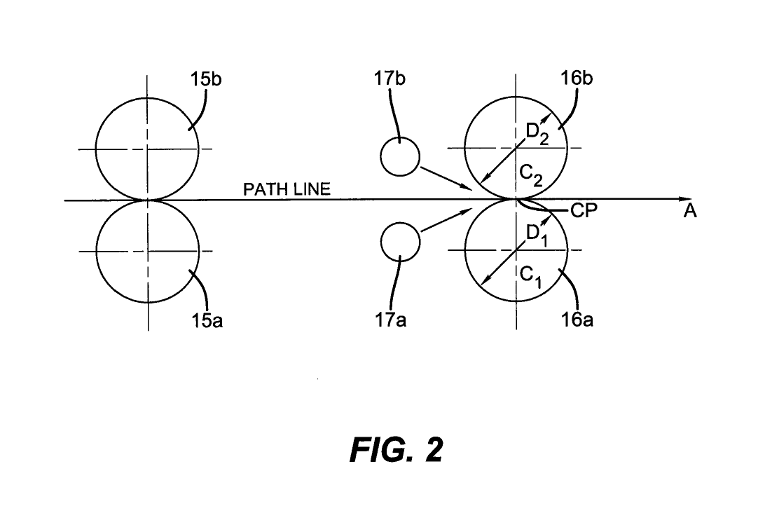

FIG. 2 shows an outline of a protective gum solution coating section of the prior art. Usually, the protective gum solution coating apparatus has a pair of conveyor rollers 15a and 15b, a pair of gum rollers 16a and 16b, and a pair of protective gum solution feeding devices 17 constituted by gum sprayers 17a and 17b. Further, the protective gum solution coating apparatus also has, before the pair of gum rollers in the direction of plate conveyance, a solution metering roll which abuts against parts of their outer circumferences and limits the amount of the protective gum solution which is given to the lithographic printing plate precursor, but this is not shown in FIG. 2.

The protective gum solution coating section of the prior art usually has the upper gum roller 16b of the gum roller pair with a diameter D₂ the same as the diameter D₁ of the lower gum roller 16a. Further, a line connecting a center C₂ of the upper gum roller 16b and a center C₁ of the lower gum roller 16a perpendicularly intersects the common tangent along the path line of the lower conveyor roller 15a and the lower gum roller 16a at the contact point CP with the lower gum roller. The contact point CP is not the point where the pair of gum rollers 16a and 16b contact. As explained later, if the upper gum roller is inclined, the point where the pair of gum rollers contact moves. In this figure, the path line is straight between the upstream conveyor rollers and the gum rollers and is superposed on the tangent. The line connecting the centers C₁ and C₂ of the pair of gum rollers 16a and 16b perpendicularly intersects the path line.

The protective gum solution is sprayed by the gum sprayers 17a and 17b on to the plate surface of the lithographic printing plate precursor. The protective gum solution which was sprayed from the gum sprayers 17a and 17b pools on the plate surface of the lithographic printing plate precursor. While the precursor is conveyed between the pair of gum rollers 16a and 16b, the pool is spread by the pair of gum rollers and the solution is uniformly coated on the surface of the printing plate precursor. After that, the lithographic printing plate precursor on which the protective gum solution has been coated leaves the pair of gum rollers and is sent to the drying section.

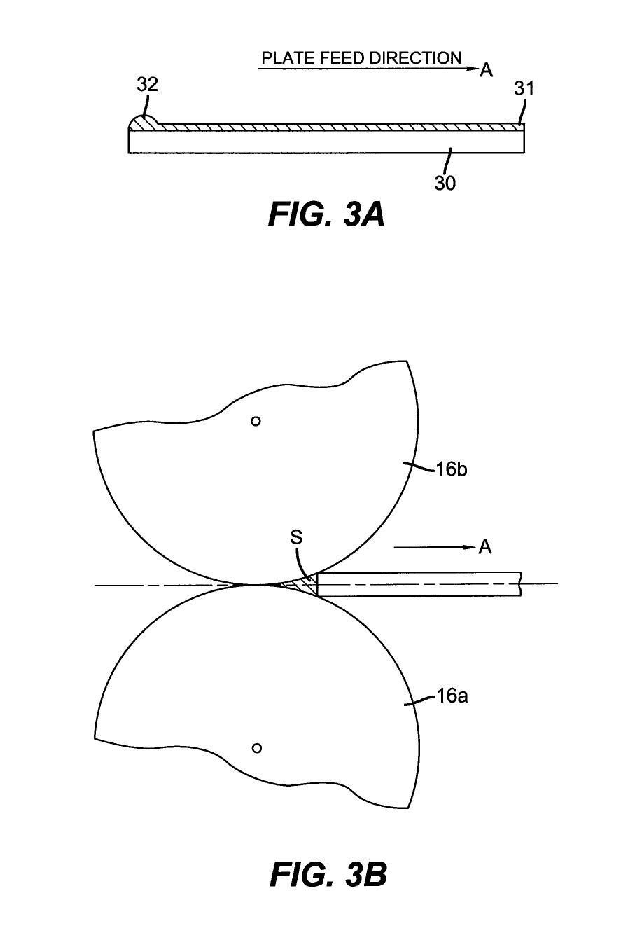

FIG. 3(a) shows the state of the lithographic printing plate precursor 30 on which the protective gum solution has been coated right after leaving a pair of gum rollers 16a and 16b of a protective gum solution coating section of the prior art. “A” shows the direction of progress of the plate (plate feed). As will be understood from this figure, the lithographic printing plate precursor is coated with the protective gum solution as a uniform layer 31, but a pool 32 of protective gum solution is observed remaining in a considerable amount on the plate surface of the rear end part of the printing plate precursor. If this remaining pool of protective gum solution is sent to the subsequent drying section, the problem arises that it will not be sufficiently dried. If such printing plates are stacked, the stacked plates will stick together (blocking).

FIG. 3(b) shows the state when leaving a pair of gum rollers 16a and 16b of the protective gum solution coating section of the prior art. After being sprayed by the protective gum solution by the gum sprayers 17a and 17b, the lithographic printing plate precursor passes through the pair of gum rollers. When the lithographic printing plate precursor separates from the pair of gum rollers, the upper gum roller 16b, the lower gum roller 16a, and the rear end part of the lithographic printing plate precursor form a closed space S. This space S contains the protective gum solution. When the lithographic printing plate precursor is further conveyed and the rear end part of the lithographic printing plate precursor separates from the pair of gum rollers 16a and 16b whereby the closed space S is opened, the protective gum solution which was inside the closed space S is believed to spring up on the plate surface of the rear end part of the plate causing the residual pool of gum solution 32.

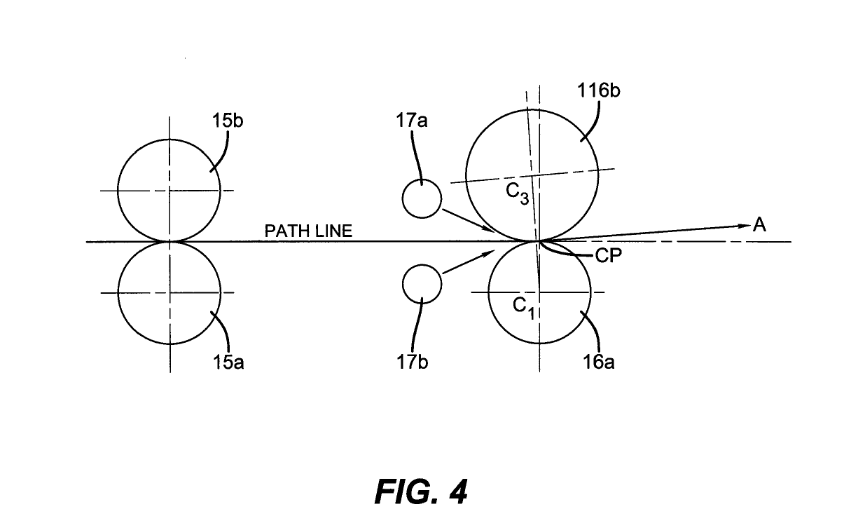

FIG. 4 shows the state of one cross-section of the protective gum solution coating apparatus of the present invention. If comparing the protective gum solution coating apparatus of the present invention and the protective gum solution coating apparatus of the prior art shown in FIG. 2, the positions and diameters of the pair of conveyor rollers 15a and 15b and the lower gum roller 16a of the pair of gum rollers are no different in the protective gum solution coating apparatus of the present invention as well. However, in the protective gum solution coating apparatus of the present invention, the upper gum roller 116b of the pair of gum rollers differs in position and further in diameter from the upper gum roller 16b of the protective gum solution coating apparatus of the prior art.

Explaining the position of the upper gum roller in detail, at the protective gum solution coating section of the prior art shown in FIG. 2, the line connecting the center C₂ of the upper gum roller 16b and the center C₁ of the lower gum roller 16a perpendicularly intersects the common tangent along the path line of the lower conveyor roller 15a and the lower gum roller 16a (superposed with the path line) at the contact point CP with the lower gum roller 16a. That is, the pair of gum rollers 16a and 16b are arranged so that the line connecting the two centers C₁ and C₂ of the pair of gum rollers 16a and 16b and the common tangent are orthogonal. As opposed to this, the upper gum roller 116b of the protective gum solution coating apparatus of the present invention shown in FIG. 4 is inclined in a direction opposite to the direction of plate progression and also differs in diameter.

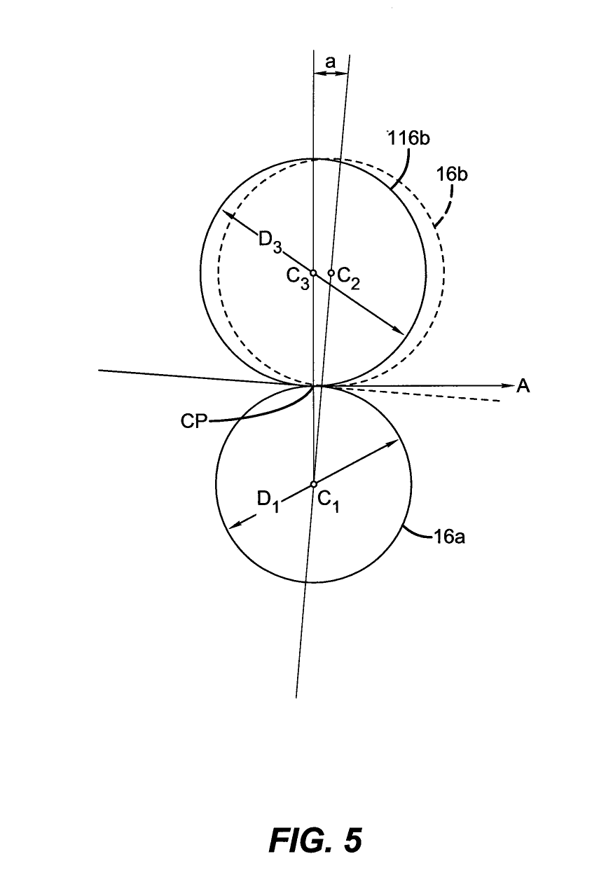

FIG. 5 is an enlarged view of a protective gum solution coating apparatus of the present invention shown in FIG. 4. The upper gum roller 16b shown in FIG. 5 by the broken line is at the position of the upper gum roller 16b of the protective gum solution coating section of the prior art. The position of the upper gum roller 116b of the protective gum solution coating apparatus of the present invention is inclined in a direction opposite to the direction A of progression of the lithographic printing plate compared even with the position of the upper roller 16b of the prior art. The slant angle “a” is the angle formed by the line connecting the center C₁ of the lower gum roller 16a and the contact point CP and the line connecting the center C₁ of the lower gum roller 16a and the center C₃ of the upper gum roller 116b (hereinafter simply referred to as the “slant angle ‘a’). As explained above, the contact point CP is not the point where the pair of gum rollers 16a and 116b contact. While not clear in this figure, the point where the pair of gum rollers 16a and 116b contact moves in a direction opposite to the direction A of progression of the lithographic printing plate. The position of the upper gum roller 116b of the protective gum solution coating apparatus of the present invention, in FIG. 5, can be said to be a position rotated by “a” degrees counterclockwise about the center C₁ of the lower gum roller 16a. Further, the point where the pair of gum rollers 16a and 116b contact is also on the circumference of the lower gum roller and can be said to be at a position rotated counterclockwise about the center C₁ of the lower gum roller 16a. Therefore, as shown in FIG. 5, the path line after passing through the pair of gum rollers 16a and 116b turns somewhat upward and separates from the tangent (shown by the broken line).

The slant angle “a” is 0<a≦5 degrees in range. In this range, it was learned that the amount of the pool of protective gum solution remaining on the plate surface at the rear end part of the plate precursor is reduced. Even if over 5 degrees, the amount of the residual gum solution decreases, but a pool of the protective gum solution tended to be observed remaining at the back surface of the plate surface of the rear end part of the plate precursor.

FIG. 5 also shows another aspect of the protective gum solution coating apparatus of the present invention. The protective gum solution coating section of the prior art, as shown in FIG. 2, usually has a diameter D₂ of the upper gum roller 16b the same as the diameter D₁ of the lower gum roller 16a, but in the protective gum solution coating apparatus of the present invention, the diameter D₃ the upper gum roller is larger than the diameter D₁ of the lower gum roller. As will be understood from the results of the embodiments explained below, by making the diameter of the upper gum roller larger than the diameter of the lower gum roller, the amount of the residual gum solution on the plate surface of the rear end part of the printing plate precursor can unexpectedly be further reduced. Referring to FIG. 5, the ratio “b” (=D₃/D₁) of the diameter D₃ of the upper gum roller 116b to the diameter D₁ of the lower gum roller 16a is preferably 1<b≦2.0. The diameter D₁ of the lower gum roller 16a is at least 20 mm. If smaller than 20 mm, it becomes difficult to uniformly coat the lithographic printing plate precursor with the gum solution. The diameter D₃ of the upper gum roller can be as much as 2.0 times the diameter D₁ of the lower gum roller, but as a practical size in a protective gum solution coating apparatus, a maximum of 90 mm is preferable.

### EXAMPLES

The following examples are provided for illustrating the working of the present invention. It is not intended by any means to limit the present invention to these examples.

In Example Nos. 1 to 8, an automatic plate processor, that is, a P-940X Plate Processor (made by Kodak), is used to process a 0.24 mm×1030 mm×790 mm lithographic printing plate precursor. An outline of the configuration of the P-940X Plate Processor and the processing conditions are as follows:

Gum solution: SWF1 (water 1:1.5 dilution), made by Kodak

Gum processing temperature/processing speed: room temperature/1,332 mm/min

Drying temperature: 50° C. to 55° C.

Tact time: 50 seconds

Example Nos. 1, 3, and 4 have a diameter D₁ of the lower gum roller the same as the diameter D₃ of the upper gum roller. The slant angle “a” of the upper gum roller position is zero. These show examples of the prior art (comparative examples).

Evaluation Method

The dried state of the center part of the plate surface of the lithographic printing plate precursor emerging from the drying unit, the state of occurrence of pools of gum at the rear end part of the plate surface, and the state of blocking when stacking processed lithographic printing plate were evaluated.

The results are shown in Table 1. Note that the dried state of the center part of the plate surface was sufficient in each of Example Nos. 1 to 8.

State of Occurrence of Residual Stationary Gum at Rear End Part of Surface (Length in Direction of Progression of Plate)

At the rear end part of the plate surface, the part with a greater thickness of the gum compared with the center part of the plate surface was defined as the residual pool of gum. The length of that part in the direction of progression of the plate was measured and the results were judged as follows:

Good: Length of residual pool of gum of less than 0.1 mm

Fair: Length of residual pool of gum of 0.1 mm to 1 mm

Poor: Length of residual pool of gum of over 1 mm

Blocking when Stacked (when Stacking 20 Plates)

To examine the state of blocking when stacking processed lithographic printing plates, the presence of any blocking was observed when stacking 20 processed lithographic printing plate - more than the usual embodiment (stacking five to 10 plates). The results were evaluated as follows:

A: No blocking

B: Blocking observed at one to two plates from bottom of stack. (However, no blocking when stacking five to 10 plates in ordinary use).

C: Blocking observed at one to four plates from bottom of stack. (However, no blocking when stacking five to 10 plates in ordinary use).

D: Blocking observed at one to five plates from bottom of stack. Blocking seen to occasionally occur even when stacking five to 10 plates in ordinary use.

TABLE 1

| | | | | | State of | |
|---|---|---|---|---|---|---|
| | | | | | occurrence | |
| | | | Upper | | of | |
| | | | gum | Dried | residual | |
| | | | roller | state | pool of | Blocking |
| | | Lower | position | of | gum at | at time of |
| | Upper | gum | slant | center | rear end | stacking |
| | gum roller | roller | angle | part of | of plate | (when |
| | diameter | diameter | “a” | plate | surface | stacking |
| No. | (D3) | (D1) | (degree) | surface | (length) | 20 plates) |
| 1 | 40 mm | 40 mm | 0 | Good | Poor | D |
| 2 | 50 mm | 40 mm | 0 | Good | Fair | C |
| 3 | 50 mm | 50 mm | 0 | Good | Poor | D |
| 4 | 69 mm | 69 mm | 0 | Good | Poor | D |
| 5 | 40 mm | 40 mm | 5 | Good | Fair | B |
| 6 | 50 mm | 50 mm | 5 | Good | Fair | B |
| 7 | 50 mm | 40 mm | 5 | Good | Good | A |
| 8 | 69 mm | 40 mm | 5 | Good | Good | A |

Gum roller material: Nitrile rubber (NBR)

In Example Nos. 1, 3, and 4 (comparative examples), blocking was seen in one to five plates from the bottom of the stack (blocking was sometimes seen even when stacking five to 10 plates as in normal use). By making the angle of the position of the upper gum roller tilt to the opposite side from the direction of progression, blocking could be completely suppressed when stacking five to 10 plates as in normal use. Further, if making the diameter of the upper gum roller larger than the diameter of the lower gum roller as well, blocking when stacking five to 10 plates as in normal use was suppressed. The effect of suppression of blocking by the slant angle of the position of the upper gum roller was larger. When both the requirements of the slant angle “a” of the position of the upper gum roller and the diameter of the upper roller are satisfied, even if stacking more than double the usual number (stacking 20), no blocking could be observed.

### PARTS LIST

10 automatic plate processor
11 development section
12 rinse section
13 protective gum solution coating section
14 drying section
15a lower upstream side rollers
15b upper upstream side rollers
16a lower downstream side rollers
16b upper downstream side rollers
17 pair of protective gum solution feeding devices
17a gum spray
17b gum spray
18 discharge opening
19 path line
20 insertion opening
30 lithographic printing plate precursor
31 uniform layer
32 pool
116b upper gum roller

1. A protective gum solution coating apparatus for coating a protective gum solution on a lithographic printing plate precursor comprising a pair of upstream side rollers in a gum section, a pair of downstream side rollers in the gum section, and a protective gum solution feeding device, wherein, in a plane orthogonal to the axes of the rollers,
when a contact point between a common tangent of a lower roller of said pair of upstream side rollers and a lower roller of said pair of downstream side rollers and the lower roller of said pair of downstream side rollers is CP,
an upper roller of said pair of downstream side rollers inclines to a direction opposite to a direction where the lithographic printing plate precursor progresses so that an angle “a” between a line which links the centers of the lower roller and the upper roller of said pair of downstream side rollers and a line which links the center of the lower roller of said pair of downstream side rollers and said contact point CP becomes 0<a≦5 degrees.

2. The protective gum solution coating apparatus according to claim 1, wherein the diameter of the upper roller of said pair of downstream side rollers is more than the diameter of the lower roller of said pair of downstream side rollers.

3. The protective gum solution coating apparatus according to claim 2, wherein a ratio “b” of the diameter of the upper roller of said pair of downstream side rollers to the diameter of the lower roller of said pair of downstream side rollers is 1<b≦2.0.

4. An automatic plate processor comprising the protective gum solution coating apparatus of claim 1.
